(19) United States
(12) Patent Application Publication
(10) Pub. No.: US 2018/0272833 A1
(43) Pub. Date: Sep. 27, 2018

(54) VEHICLE HVAC SYSTEM WITH SLIDING DOOR

(71) Applicants: Hyundai Motor Company, Seoul (KR); Kia Motors Corporation, Seoul (KR); Hanon Systems, Daejeon (KR)

(72) Inventors: Kyeong-Hyeon Lee, Hwaseong-si (KR); Yong-Chul Kim, Hwaseong-si (KR); Jun-Chul An, Daejeon (KR)

(73) Assignees: Hyundai Motor Company, Seoul (KR); Kia Motors Corporation, Seoul (KR); Hanon Systems, Daejeon (KR)

(21) Appl. No.: 15/858,199

(22) Filed: Dec. 29, 2017

(30) Foreign Application Priority Data
Mar. 22, 2017 (KR) 10-2017-0035990

(51) Int. Cl. B60H 1/00

(52) U.S. Cl. CPC B60H 1/00064; B60H 1/0055; B60H 2001/00092; B60H 2001/00107; B60H 2001/00178; B60H 1/00028

(57) ABSTRACT

A vehicle HVAC system may include a housing, a blower disposed in the housing to blow air, an evaporator core disposed in the housing to cool the air having passed through the blower, a heater core disposed in the housing to increase a temperature of the air having passed through the evaporator core, a temperature door assembly including a pair of slidable temperature door plates to control the air having passed through the blower, and a mode door assembly including a slidable mode door plate to control a vent outlet and a floor outlet such that one thereof is closed, or to control air to be discharged through the vent outlet and the floor outlet.

### CROSS-REFERENCE TO RELATED APPLICATIONS

The present application claims priority to Korean Patent Application No. 10-2017-0035990, filed on Mar. 22, 2017, the entire contents of which is incorporated herein for all purposes by this reference.

### BACKGROUND OF THE INVENTION

### Field of the Invention

The present invention relates to a heating, ventilation, and air conditioning (HVAC) system which is used to cool or heat a vehicle internal; and, more particularly, to a vehicle HVAC system with a sliding door, which is used for mode control and temperature control to determine a flow direction of air and occupies a small space by allowing a door used to determine a flow rate of cold and hot air to be opened and closed in a sliding manner.

### Description of Related Art

A vehicle includes a heating, ventilation, and air conditioning (HVAC) system which is used to supply conditioned air thereinto. The HVAC system supplies cold air and hot air or a mixture thereof into the vehicle to control the temperature and humidity inside the vehicle.

Furthermore, the HVAC system allows conditioned air to be supplied directly to the internal of the vehicle or allows conditioned air to be supplied to the floor of the vehicle, according to the operation mode of the HVAC system.

FIG. 1 illustrates a conventional HVAC system. A conventional HVAC system 100 includes a blower 112 internally disposed within a housing 111 for blowing air. The air blown by the blower 112 passes through an evaporator core 113, which is one component of an air conditioner, to be cold air, or passes through a heater core 114 to be hot air. The cold air or the hot air is discharged to the upper body of an occupant from the housing 111 (vent mode) or is discharged to the floor of a vehicle from the housing 111 (floor mode).

In the instant case, the housing 111 is provided therein with a temperature door 130 for controlling the temperature of air discharged from the HVAC system 100, and a mode door 120 for controlling the direction of wind.

That is, the opening angle of the temperature door 130 is adjusted in the housing 111 to deliver the air discharged from the blower 112 to one of the evaporator core 113 and the heater core 114, or to both of the evaporator core 113 and the heater core 114 at a fixed rate, controlling the temperature of air discharged from the HVAC system 100.

Furthermore, the opening amount of the mode door 120 is adjusted so that air is blown in one of the vent and floor modes or air is blown in a bi-level mode in which air is simultaneously blown to the upper body of the occupant and the floor of the vehicle.

However, each of the temperature door 130 and the mode door 120 is a swing-type door, one end portion of which is connected to the internal portion of the housing 111 by a hinge for rotation of the door. Therefore, there is a demand for a space in which the temperature door 130 and the mode door 120 are able to swing. Thus, since the space for operation of the temperature door 130 and the mode door 120 is necessarily required, there is a limitation in reducing the volume of the conventional HVAC system 100.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a vehicle HVAC system with a sliding door, configured for having a small size to operate even in a small space by operating a temperature door for controlling a temperature of blown air and a mode door for controlling a mode in a sliding manner.

Other various aspects of the present invention can be understood by the following description, and become apparent with reference to the exemplary embodiments of the present invention. Also, it is obvious to those skilled in the art to which the present invention pertains that the objects and advantages of the present invention can be realized by the means as claimed and combinations thereof.

In accordance with various exemplary embodiments of the present invention, a vehicle HVAC system with a sliding door may include a housing, a blower disposed in the housing to blow air, an evaporator core disposed in the housing to cool the air having passed through the blower, a heater core disposed in the housing to increase a temperature of the air having passed through the evaporator core, a temperature door assembly including a pair of slidable temperature door plates facing each other to control the air having passed through the blower to pass through, not to pass through, or to partially pass through the heater core, and a mode door assembly including a slidable mode door plate to control a vent outlet for discharge of conditioned air to an upper body of an occupant and a floor outlet for discharge of conditioned air to a vehicle internal such that one thereof is closed, or to control air to be discharged through the vent outlet and the floor outlet at a fixed rate.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view illustrating a conventional HVAC system.

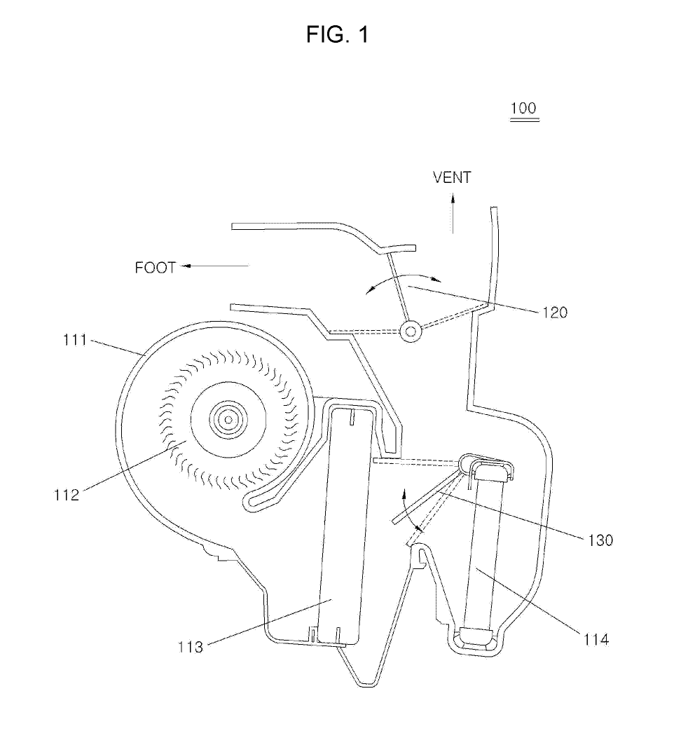

FIG. 2 is a cross-sectional view illustrating a vehicle HVAC system with a sliding door according to an exemplary embodiment of the present invention.

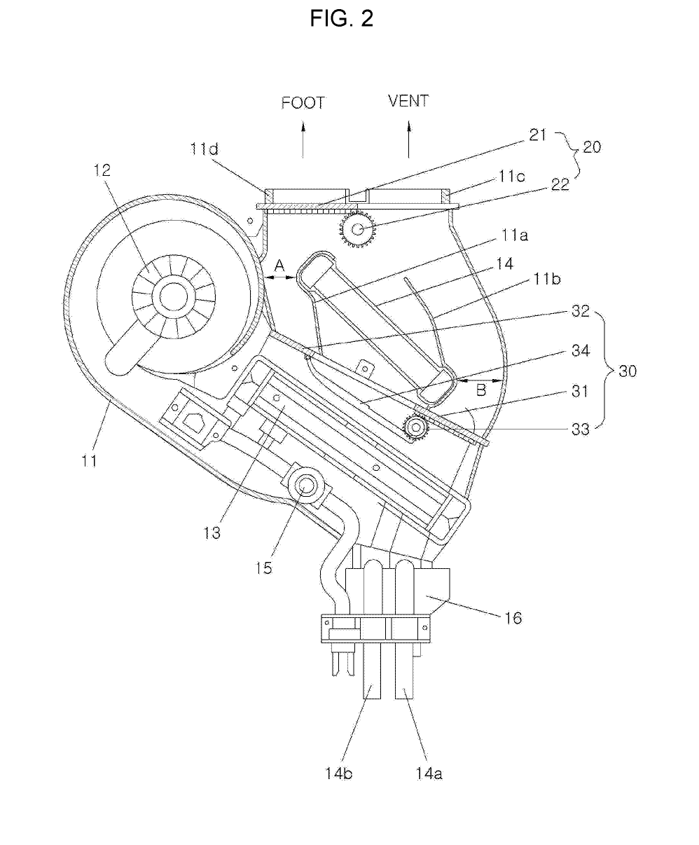

FIG. 3 is a bottom perspective view illustrating a mode door assembly in the vehicle HVAC system with a sliding door according to the exemplary embodiment of the present invention.

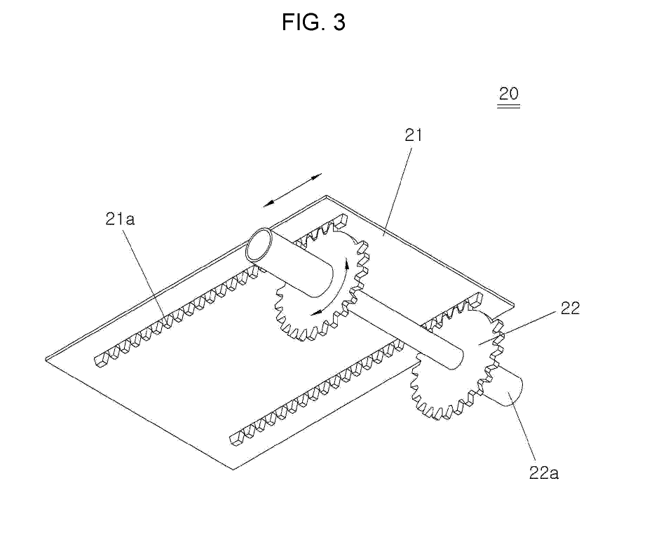

FIG. 4 is a bottom perspective view illustrating a temperature door assembly in the vehicle HVAC system with a sliding door according to the exemplary embodiment of the present invention.

FIG. 5 is a partial perspective view illustrating a bracket in the vehicle HVAC system with a sliding door according to the exemplary embodiment of the present invention.

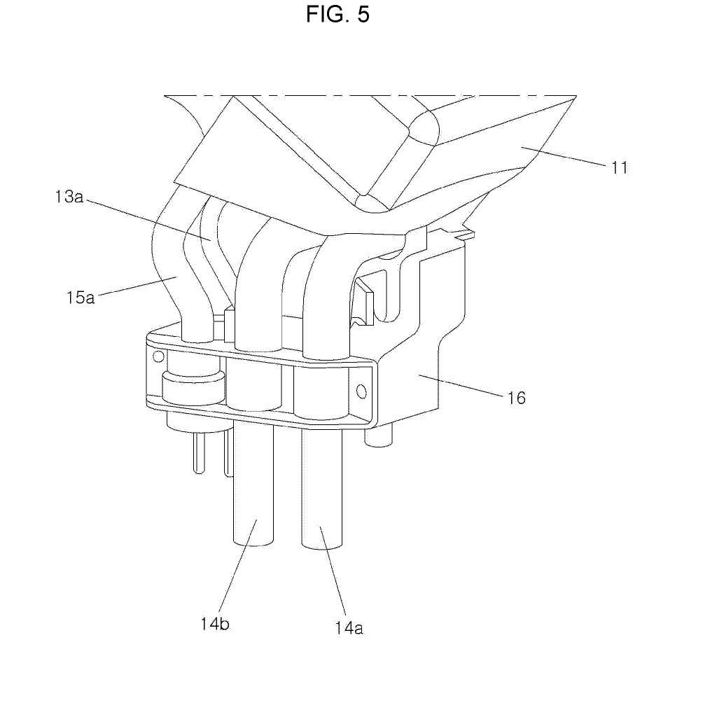

FIG. 6 is a cross-sectional view illustrating an operation of the vehicle HVAC system with a sliding door in a vent mode during cooling according to the exemplary embodiment of the present invention.

FIG. 7 is a cross-sectional view illustrating an operation of the vehicle HVAC system with a sliding door in a vent mode during half-cooling according to the exemplary embodiment of the present invention.

FIG. 8 is a cross-sectional view illustrating an operation of the vehicle HVAC system with a sliding door in a vent mode during heating according to the exemplary embodiment of the present invention.

FIG. 9 is a cross-sectional view illustrating an operation of the vehicle HVAC system with a sliding door in a bi-level mode during cooling according to the exemplary embodiment of the present invention.

FIG. 10 is a cross-sectional view illustrating an operation of the vehicle HVAC system with a sliding door in a bi-level mode during half-cooling according to the exemplary embodiment of the present invention.

FIG. 11 is a cross-sectional view illustrating an operation of the vehicle HVAC system with a sliding door in a bi-level mode during heating according to the exemplary embodiment of the present invention.

FIG. 12 is a cross-sectional view illustrating an operation of the vehicle HVAC system with a sliding door in a floor mode during cooling according to the exemplary embodiment of the present invention.

FIG. 13 is a cross-sectional view illustrating an operation of the vehicle HVAC system with a sliding door in a floor mode during half-cooling according to the exemplary embodiment of the present invention.

FIG. 14 is a cross-sectional view illustrating an operation of the vehicle HVAC system with a sliding door in a floor mode during heating according to the exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the intended application and use environment.

In the figures, reference numbers refer to the same or equivalent parts of the present invention throughout the several figures of the drawing.

### DETAILED DESCRIPTION

Reference will now be made more specifically to the exemplary embodiments of the present invention, examples of which are illustrated in the accompanying drawings. The present invention may, however, be embodied in different forms and should not be construed as limited to the exemplary embodiments set forth herein. Rather, these embodiments are provided so that the present disclosure will be thorough and complete, and will fully convey the scope of the present invention to those skilled in the art. Throughout the disclosure, like reference numerals refer to like parts throughout the various figures and embodiments of the present invention. Hereinafter, a vehicle heating, ventilation, and air conditioning (HVAC) system with a sliding door according to exemplary embodiments of the present invention will be described more specifically with reference to the accompanying drawings.

A vehicle HVAC system with a sliding door 1 according to an exemplary embodiment of the present invention includes a housing 11, a blower 12 which is disposed in the housing 11 to blow air, an evaporator core 13 which is disposed in the housing 11 to cool the air having passed through the blower 12, a heater core 14 which is disposed in the housing 11 to increase the temperature of the air having passed through the evaporator core 13, a temperature door assembly 30 that includes a pair of slidable temperature door plates 31 and 32 facing each other to control the air having passed through the blower 12 to pass through, not to pass through, or to partially pass through the heater core 14, and a mode door assembly 20 that includes a slidable mode door plate 21 to control a vent outlet 11c for discharge of conditioned air to the upper body of an occupant and a floor outlet lid for discharge of conditioned air to a vehicle internal such that one thereof is closed, or to control air to be discharged through the vent outlet 11c and the floor outlet 11d at a fixed rate.

The housing 11 defines the external appearance of the vehicle HVAC system 1 according to the exemplary embodiment of the present invention. Air is introduced through one side of the housing 11 from the inside or outside of a vehicle, and is conditioned in the housing 11 and then discharged therefrom.

The heater core 14 is disposed in the housing 11, and a plurality of guides 11a and 11b are formed in the housing 11 to guide the air flow therein.

Among the guides, a first guide 11a is formed adjacent to the blower 12, and a second guide 11b is distanced from the first guide 11a. The heater core 14 is disposed between the first guide 11a and the second guide 11b. The bypass passages of the heater core 14 are spaces between one internal surface of the housing 11 and the first guide 11a and between the other internal surface of the housing 11 and the second guide 11b.

A plurality of outlets is formed in a discharge portion of air from the housing 11 such that air is discharged to different ducts according to a blowing mode. That is, the vent outlet 11c, which is connected to a vent duct for blowing air in a vent mode in which conditioned air is discharged to the upper body of the occupant, and the floor outlet 11d, which is connected to a floor duct for blowing air in a floor mode in which conditioned air is discharged to the floor of the vehicle internal, are formed. The vent outlet 11c and the floor outlet 11d are formed adjacent to each other, and each of the vent outlet 11c and the floor outlet 11d is partially opened in a bi-level mode in which air is blown only through one of the vent outlet 11c and the floor outlet 11d, or air is simultaneously blown to the upper body of the occupant and the floor of the vehicle internal.

The blower 12 is disposed at one side of the housing 11, and presses the air introduced into the housing 11 to supply the air to the vehicle internal.

The evaporator core 13 is disposed in the housing 11, and the air having passed through the blower 12 passes through the evaporator core 13. The evaporator core 13 is one component of an air conditioner, and the air passing through the evaporator core 13 is cooled while a refrigerant is evaporated in the evaporator core 13. The refrigerant is circulated in the evaporator core 13 only when it is necessary to cool the air passing through the evaporator core 13.

The heater core 14 is disposed downstream of the evaporator core 13 in the housing 11 such that the air having passed through the evaporator core 13 passes through the heater core 14. The temperature of the air passing through the heater core 14 is increased by the flow of a heated fluid, e.g., engine coolant in the heater core 14. The heated fluid flows into the heater core 14 only when it is necessary to increase the temperature of the air passing through the heater core 14.

Meanwhile, the heater core 14 is preferably disposed such that both end portions of the heater core 14 are distanced from the respective internal surfaces of the housing 11 by a fixed distance in the installation portion of the heater core 14. When the heater core 14 is disposed such that one of both end portions thereof is in contact with an associated one of the internal surfaces of the housing 11, the flow of the air having passed through the heater core 14 is biased to one of the vent outlet 11c and the floor outlet 11d. Thus, since the difference in temperature between the vent outlet 11c and the floor outlet 11d is increased, both end portions of the heater core 14 are distanced from the respective internal surfaces of the housing 11 by the fixed distance. The first and second guides 11a and 11b are distanced from the respective internal surfaces of the housing 11. Therefore, when the first and second guides 11 and 11b are mounted to both end portions of the heater core 14, both end portions of the heater core 14 are distanced from the respective internal surfaces of the housing 11.

Especially, the heater core 14 is preferably positioned at an intermediate portion between the internal surfaces of the housing 11 in the installation portion of the heater core 14. For example, a distance A between one internal surface of the housing 11 and the first guide 11a distance B between the other internal surface of the housing 11 and the second guide 11b may be formed to be 5:6. In the instant case, the difference in temperature between the vent outlet 11c and the floor outlet 11d is smallest.

An expansion valve 15 is configured to expand the refrigerant introduced into the evaporator core 13.

The mode door assembly 20 is disposed at the outlet side of the housing 11 to control the air discharged from the housing 11 to be discharged to one of the vent outlet 11c and the floor outlet 11d, or to be discharged to both of the vent outlet 11c and the floor outlet 11d.

To the present end, the mode door assembly 20 includes a mode door plate 21 which is slidably disposed at the inlets of the vent outlet 11c and the floor outlet 11d, and a mode door drive gear 22 that slides the mode door plate 21. The blowing mode of the HVAC system 1 is determined according to the operation of the mode door assembly 20. That is, the mode door assembly 20 is operated in the vent mode in which air is blown only to the upper body of the occupant, in the floor mode in which air is blown only to the floor of the vehicle internal, or in the bi-level mode in which air is simultaneously blown to both of the upper body of the occupant and the floor of the vehicle internal.

In the case where the mode door plate 21 slides between the inlet of the vent outlet 11c and the inlet of the floor outlet 11d, when one thereof is closed, the other thereof is opened. In the case where the mode door plate 21 is positioned between the inlet of the vent outlet 11c and the inlet of the floor outlet lid, the inlet of the vent outlet 11c and the inlet of the floor outlet 11d are partially opened. The mode door plate 21 has a rack gear 21a which is formed on the bottom thereof in the sliding direction of the mode door plate 21.

The mode door drive gear 22 is disposed to be rotated by a drive motor. The mode door drive gear 22 engages with the rack gear 21a of the mode door plate 21. Thus, when the mode door drive gear 22 rotates, the mode door plate 21 slides. The sliding direction of the mode door plate 21 is determined according to the direction of rotation of the mode door drive gear 22.

Meanwhile, the rack gear 21a of the mode door plate 21 includes rack gears distanced from each other by a distance. Thus, the mode door drive gear 22 may include a pair of mode door drive gears that are distanced from each other by a distance and are connected to each other by a shaft 22a.

Furthermore, the mode door drive gear 22 does not have teeth on a portion of the circumference thereof, facilitating the mode door plate 21 to slide only in a fixed range.

The temperature door assembly 30 controls the air having passed through the evaporator core 13 to flow to the heater core 14 to control the temperature of the air blown thereto.

The temperature door assembly 30 includes a first temperature door plate 31 which is disposed to slide in front of the heater core 14, a second temperature door plate 32 which is disposed to slide in a direction in which it is close to or further distanced from the first temperature door plate 31 at a position in which it is distanced from therefrom, and a temperature door drive gear 33 that slides the first and second temperature door plates 31 and 32 by rotation thereof.

The first temperature door plate 31 is disposed to slide in front of the heater core 14. The first temperature door plate 31 slides in a direction intersecting with the second guide 11b, and allows the air having passed through the evaporator core 13 to be introduced into the heater core 14 or bypass the heater core 14 in the portion adjacent to the second guide 11b.

The first temperature door plate 31 has rack gears 31a formed on the bottom thereof, and the rack gears 31a engage with the temperature door drive gear 33 and are distanced from each other by a distance in the sliding direction of the first temperature door plate 31.

The second temperature door plate 32 is slidably disposed at a position in which it is distanced from the first temperature door plate 31. When the second temperature door plate 32 slides in a direction intersecting with the first guide 11a in front of the heater core 14, similar to the first temperature door plate 31, the air having passed through the evaporator core 13 is introduced into the heater core 14 or bypasses the heater core 14 in the portion adjacent to the first guide 11a.

The second temperature door plate 32 is positioned on the substantially same plane as the first temperature door plate 31.

Furthermore, the first and second temperature door plates 31 and 32 interlock with each other to simultaneously slide in opposite directions. Thus, when the first and second temperature door plates 31 and 32 slide in a direction close to each other, the introduction of air into the heater core 14 is blocked between the first guide 11a and the second guide 11b so that the entire air having passed through the evaporator core 13 bypasses the heater core 14. Furthermore, when the first and second temperature door plates 31 and 32 slide such that they are fully distanced from each other, the first temperature door plate 31 closes a passage between the second guide 11b and the associated internal surface of the housing 11, and the second temperature door plate 32 closes a passage between the first guide 11a and the associated internal surface of the housing 11. Consequently, the entire air having passed through the evaporator core 13 bypasses the heater core 14. When the distance between the first temperature door plate 31 and the second temperature door plate 32 is adjusted, a portion of the air having passed through the evaporator core 13 may pass through the heater core 14 and the other thereof may bypass the heater core 14.

The temperature door drive gear 33 is disposed to be rotated by a drive motor. The temperature door drive gear 33 engages with the rack gears 31a formed on the first temperature door plate 31 to slide the first temperature door plate 31. The temperature door drive gear 33 may include a plurality of temperature door drive gears distanced from each other by the installation distance of the rack gears 31, and the spaced temperature door drive gears 33 may be connected to each other by a shaft 33a.

An interlocking link 34 allows the first and second temperature door plates 31 and 32 to interlock and slide in opposite directions. One end portion of the interlocking link 34 is connected to the bottom portion of the second temperature door plate 32 by a hinge, and the other end portion thereof is formed with a rack gear 34a by a fixed length therefrom to engage with the temperature door drive gear 33. In the instant case, the interlocking link 34 may engage with an interlocking gear 33b which is formed integrally with the temperature door drive gear 33 at the external side thereof.

The temperature door drive gear 33 and the interlocking gear 33b may not also have teeth in some portions such that the first and second temperature door plates 31 and 32 slide only in a fixed range.

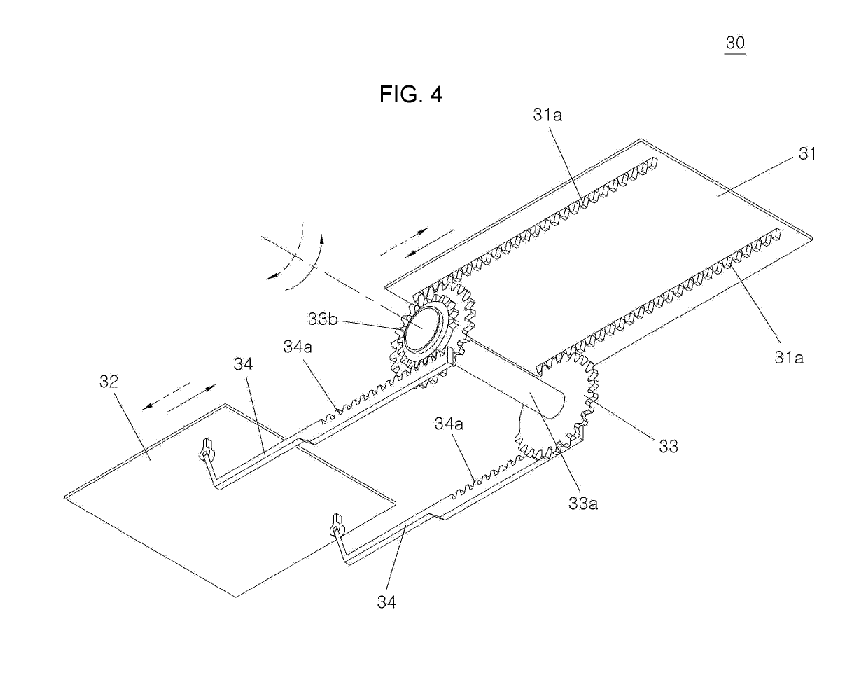

Through such a configuration, when the temperature door drive gear 33 rotates in one direction thereof, the first and second temperature door plates 31 and 32 slide in opposite directions. For example, when the temperature door drive gear 33 rotates in the direction of the solid arrow in FIG. 4, the first and second temperature door plates 31 and 32 slide in the direction of the solid arrow. When the temperature door drive gear 33 rotates in the direction of the dotted arrow in FIG. 4, the first and second temperature door plates 31 and 32 slide in the direction of the dotted arrow.

Meanwhile, the housing 11 is provided, at the lower portion thereof, with a bracket 16 that simultaneously fixes a supply pipe 14a for supply of a heated fluid into the heater core 14, a discharge pipe 14b for discharge of the fluid having passed through the heater core 14, a refrigerant pipe 15a for supply of a cooled refrigerant to the evaporator core 13, and a discharge tube 13a for discharge of the refrigerant having passed through the evaporator core 13.

Since the supply pipe 14a, the discharge pipe 14b, the refrigerant pipe 15a, and the discharge tube 13a are bound by the bracket 16, they may be assembled once.

The operation of the vehicle HVAC system having the above-mentioned configuration according to the exemplary embodiment of the present invention will be described below.

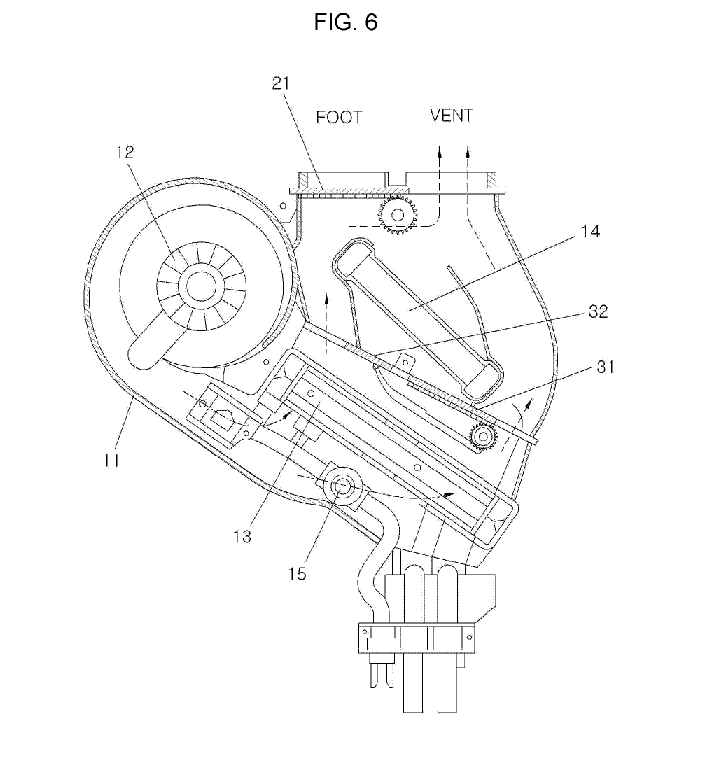

FIGS. 6 to 14 illustrate the air flow in the vehicle HVAC system 1 according to the operation state of the mode door assembly 20 and the operation state of the temperature door assembly 30.

FIG. 6 illustrates the state of operation of the vehicle HVAC system in the vent mode during cooling. The mode door assembly 20 is operated to close the floor outlet 11d. In the temperature door assembly 30, the first and second temperature door plates 31 and 32 slide to be adjacent to each other between the first guide 11a and the second guide 11b, and thus the introduction of air into the heater core 14 is blocked. When the blower 12 is operated in the present state, the air having passed through the blower 12 is cooled through the evaporator core 13, in which a refrigerant is circulated, and is then blown to the vent outlet 11c through between the first guide 11a and the associated internal surface of the housing 11 and between the second guide 11b and the associated internal surface of the housing 11, so that cold air is supplied to the upper body of the occupant.

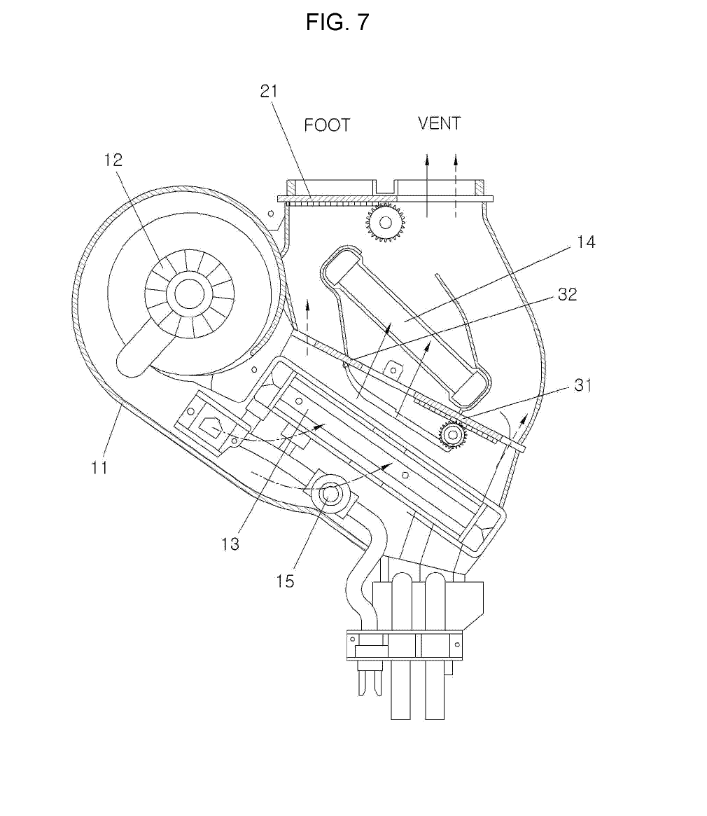

FIG. 7 illustrates the state of operation of the vehicle HVAC system in the vent mode during half-cooling, i.e. the state in which conditioned air is blown to the internal at an occupant's desired temperature. The mode door assembly 20 is maintained in the state illustrated in FIG. 6. In the temperature door assembly 30, the temperature door drive gear 33 is operated so that the first temperature door plate 31 is distanced from the second temperature door plate 32 and the first and second temperature door plates 31 and 32 are also distanced from the internal surfaces of the housing 11. Accordingly, a portion of the sir cooled by the evaporator core 13 passes through between the first guide 11a and the associated internal surface of the housing 11 and between the second guide 11b and the associated internal surface of the housing 11 in the cooled state, and the other thereof increases in temperature while passing through the heater core 14. As such, they are mixed to be conditioned to a predetermined temperature before they are discharged through the vent outlet 11c, and are then supplied to the internal. Here, it is possible to control the temperature of air supplied to the vehicle internal by adjusting the positions of the first and second temperature door plates 31 and 32.

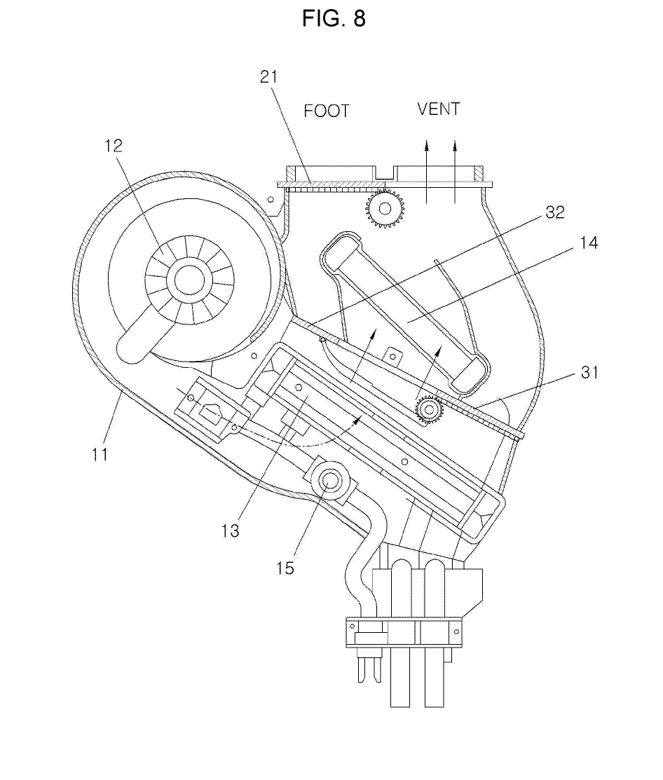

FIG. 8 illustrates the state of operation of the vehicle HVAC system in the vent mode during heating. Similar to FIG. 6 and FIG. 7, the mode door assembly 20 is operated so that the mode door plate 21 closes the floor outlet 11d in the vent mode. In the temperature door assembly, the temperature door drive gear 33 slides the first and second temperature door plates 31 and 32 so that they are fully spaced from each other. In the state in which the first and second temperature door plates 31 and 32 are fully distanced from each other, the first temperature door plate 31 closes the passage between the housing 11 and the second guide 11b, and the second temperature door plate 323 closes the passage between the housing 11 and the first guide 11a. Thus, the entire air having passed through the evaporator core 13 passes through the heater core 14. Since a refrigerant is not circulated in the evaporator core 13 during heating, air is not cooled in the evaporator core 13 and increases in temperature while passing through the heater core 14. The air, the temperature of which is increased, is discharged through the vent outlet 11c.

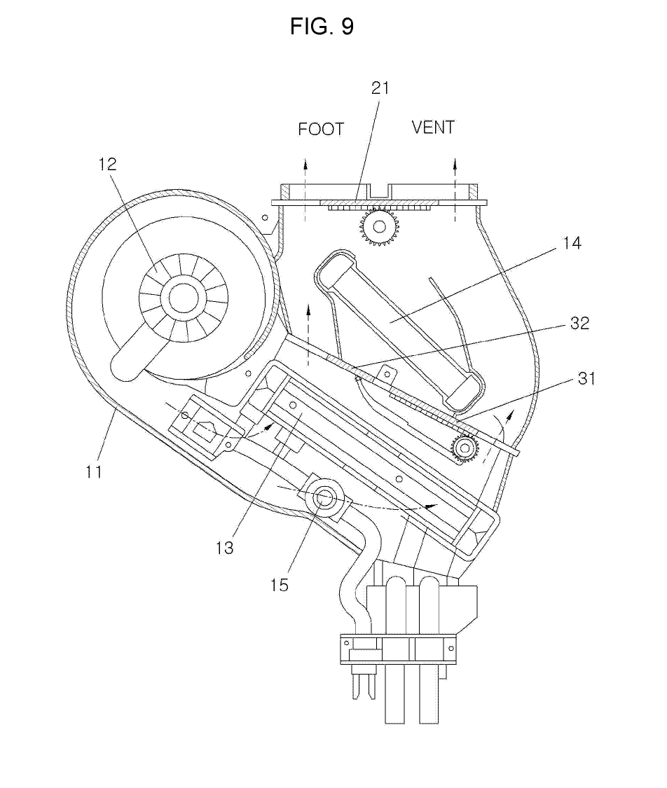

FIG. 9 illustrates the state of operation of the vehicle HVAC system in the bi-level mode during cooling. In the bi-level mode, the mode door assembly is operated such that the mode door drive gear 22 slides the mode door plate 21 toward the vent outlet 11e and the mode door plate 21 partially opens the floor outlet 11d and the vent outlet 11c. Therefore, conditioned air is blown through the floor outlet 11d and the vent outlet 11c. Meanwhile, it is possible to control a ratio between an air volume at the floor outlet 11d and an air volume at the vent outlet 11c by adjusting the position of the mode door plate 21. The temperature door assembly 30 is adjusted in the state illustrated in FIG. 6. Accordingly, the air having passed through the blower 12 is cooled through the evaporator core 13, in which a refrigerant is circulated, and is then blown to the vent outlet 11c and the floor outlet 11d through between the first guide 11a and the associated internal surface of the housing 11 and between the second guide 11b and the associated internal surface of the housing 11, so that cold air is supplied to the upper body of the occupant and to the floor of the vehicle internal.

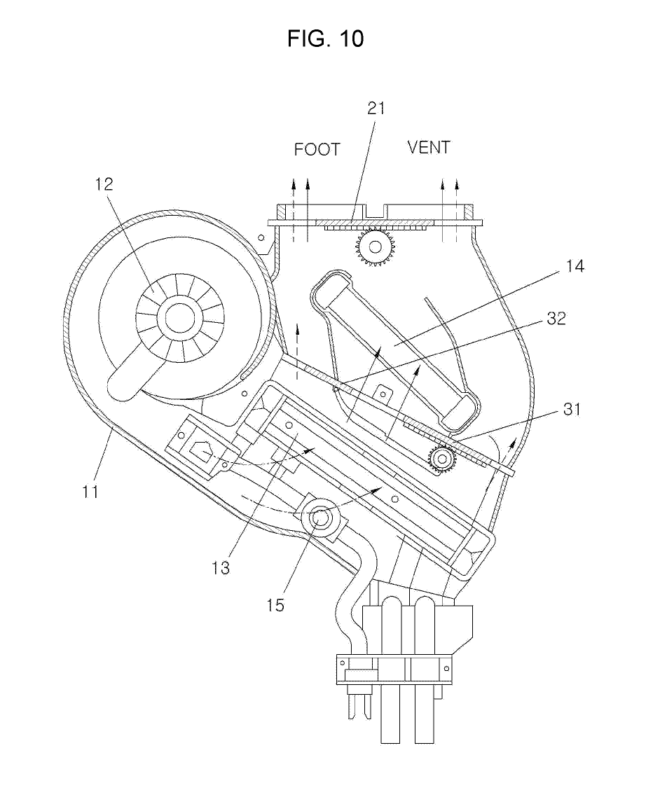

FIG. 10 illustrates the state of operation of the vehicle HVAC system in the bi-level mode during half-cooling. In the instant case, the mode door assembly 20 is in the state illustrated in FIG. 9, and the temperature door assembly 30 is in the state illustrated in FIG. 7. Accordingly, a portion of the sir cooled by the evaporator core 13 passes through between the first guide 11a and the associated internal surface of the housing 11 and between the second guide 11b and the associated internal surface of the housing 11 in the cooled state, and the other thereof increases in temperature while passing through the heater core 14. As such, they are mixed to be conditioned to a predetermined temperature before they are discharged through the vent outlet 11c and the floor outlet 11d, and are then supplied to the internal. Similar to FIG. 7, it is possible to control the temperature of air supplied to the vehicle internal by adjusting the positions of the first and second temperature door plates 31 and 32.

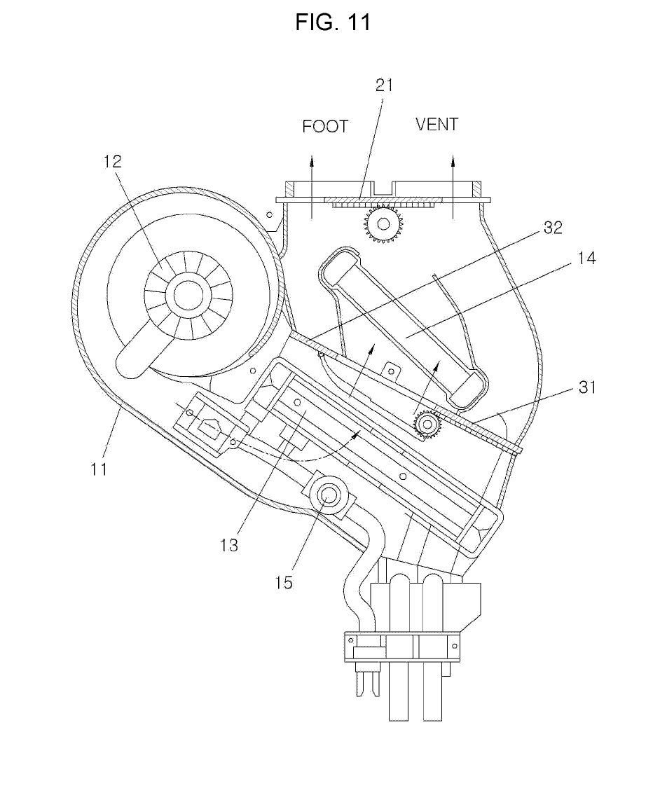

FIG. 11 illustrates the state of operation of the vehicle HVAC system in the bi-level mode during heating. The mode door assembly 20 is in the state illustrated in FIG. 9 or FIG. 10, the temperature door assembly 30 is in the state illustrated in FIG. 8. The air having passed through the blower 12 increased in temperature while passing through the heater core 14, and is then supplied to the internal through the vent outlet 11c and the floor outlet 11d.

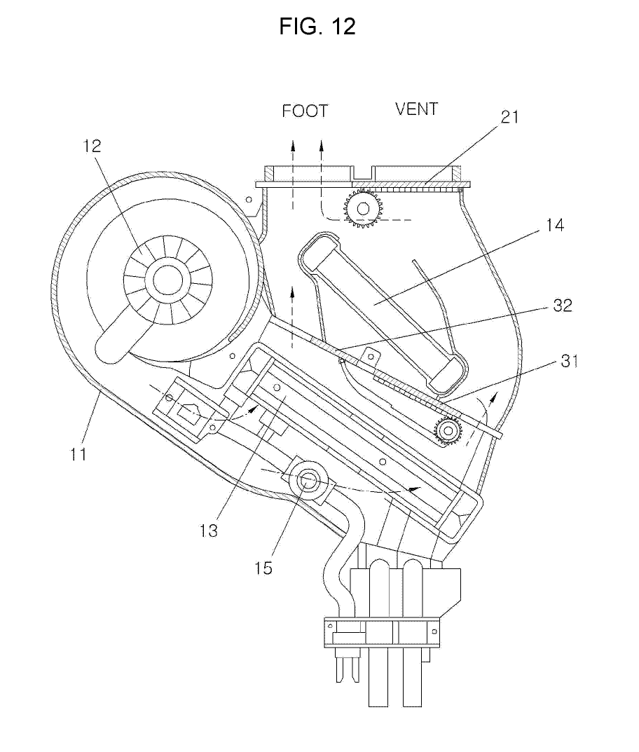

FIG. 12 illustrates the state of operation of the vehicle HVAC system in the floor mode during cooling. In the mode door assembly 20, the mode door drive gear 22 fully slides the mode door plate 21 toward the vent outlet 11c, so that the mode door plate 21 closes the vent outlet 11c and fully opens the floor outlet 11d. During cooling, the temperature door assembly is in the state illustrated in FIGS. 6 and 9. The air having passed through the blower 12 is cooled by the evaporator core, and then bypasses the heater core 14 so that cold air is supplied through the floor outlet 11d to the floor of the vehicle internal.

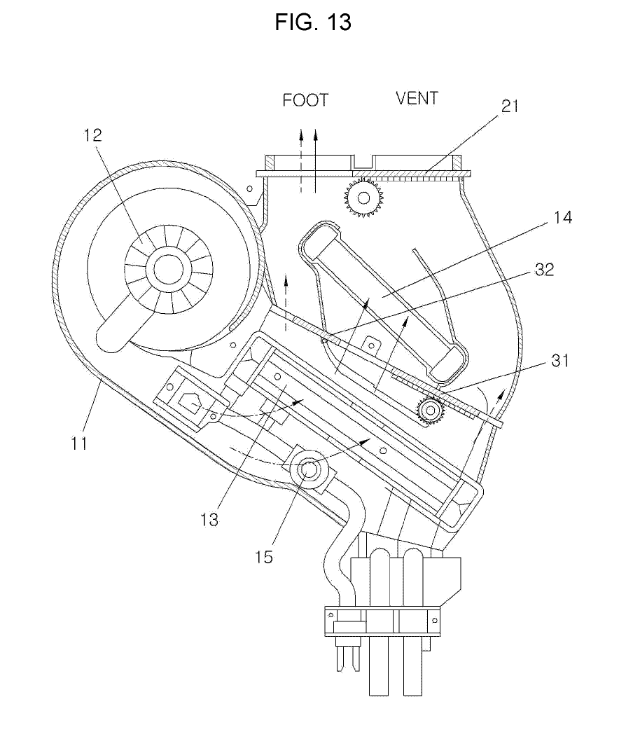

FIG. 13 illustrates the state of operation of the vehicle HVAC system in the floor mode during half-cooling. In the instant case, the mode door assembly 20 is in the state illustrated in FIG. 9, and the temperature door assembly 30 is in the state illustrated in FIG. 7 or 10. The air blown by the blower 12 is conditioned to a proper temperature through the evaporator core 13 and the heater core 14, and is then blown to the vehicle internal through the floor outlet 11d.

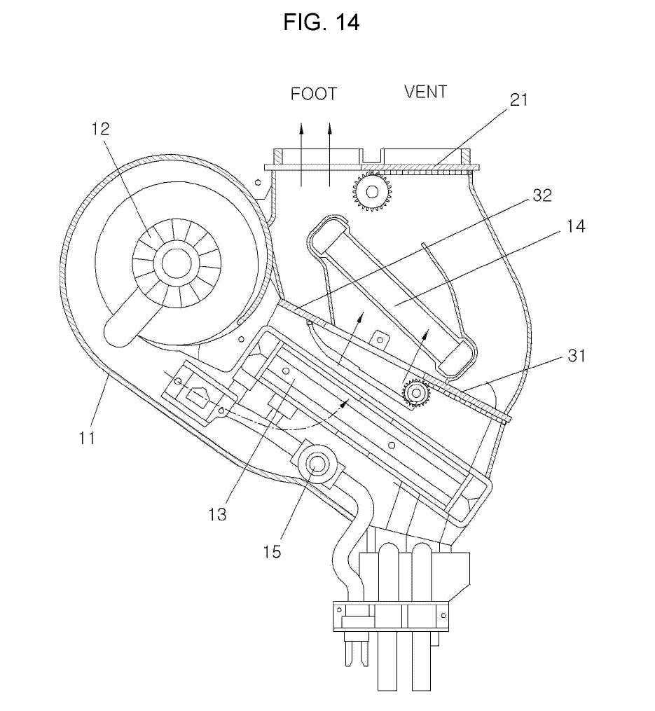

FIG. 14 illustrates the state of operation of the vehicle HVAC system in the floor mode during heating. The mode door assembly 20 is in the state illustrated in FIG. 12 or 13, and the temperature door assembly 30 is in the state illustrated in FIG. 8 or 11. The air having passed through the blower 12 increases in temperature while passing through the heater core 14, and is then supplied to the internal through the floor outlet 11d.

In accordance with a vehicle HVAC system with a sliding door of the present invention, since both of a temperature door and a mode door are opened and closed in a sliding manner, there is no demand for a space to open or close the temperature door and the mode door. Therefore, the vehicle HVAC system can have a small size.

Furthermore, since the HVAC system is disposed in a reduced space within a vehicle by the reduction in size of the HVAC system, it is possible to enlarge a vehicle internal.

Moreover, the HVAC system can be applied to and used in common for many vehicles by the reduction in size of the HVAC system.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle heating, ventilation, and air conditioning (HVAC) system with a sliding door, comprising:
a housing;
a blower disposed in the housing to blow air;
an evaporator core disposed in the housing to cool the air having passed through the blower;
a heater core disposed in the housing to increase a temperature of the air having passed through the evaporator core;
a temperature door assembly including a pair of slidable temperature door plates facing each other to control the air having passed through the blower to pass through, not to pass through, or to partially pass through the heater core; and
a mode door assembly including a slidable mode door plate to control a vent outlet for discharge of conditioned air to a predetermined direction and a floor outlet for discharge of the conditioned air to a vehicle internal such that one thereof is closed, or to control air to be discharged through the vent outlet and the floor outlet at a fixed rate.

2. The vehicle HVAC system of claim 1, wherein
the housing is provided therein with a first guide for fixing a first end portion of the heater core, which is adjacent to the blower, and a second guide for fixing a second end portion of the heater core; and
the first and second guides are distanced from respective internal surfaces of the housing.

3. The vehicle HVAC system of claim 2, wherein a distance between the first guide and one of the internal surfaces of the housing and a distance between the second guide and another of the internal surfaces of the housing are 5:6.

4. The vehicle HVAC system of claim 3, wherein the temperature door assembly includes:
a first temperature door plate slidably disposed in a front of the heater core to open or close between the second guide and the associated internal surface of the housing; and
a temperature door drive gear rotated by a drive motor to slide the first temperature door plate.

5. The vehicle HVAC system of claim 4, wherein
the first temperature door plate has a rack gear formed in a sliding direction of the
first temperature door plate on a bottom portion thereof;
the rack gear engages with the temperature door drive gear; and
the first temperature door plate slides when the temperature door drive gear rotates.

6. The vehicle HVAC system of claim 4, wherein the temperature door assembly further includes:
a second temperature door plate distanced from the first temperature door plate and slidably disposed in a front of the heater core to open or close between the first guide and the associated internal surface of the housing; and
an interlocking link configured to slide the second temperature door plate when the temperature door drive gear rotates such that the second temperature door plate slides in a direction in which the second temperature door plate slides is adjacent to or away from the first temperature door plate.

7. The vehicle HVAC system of claim 6, wherein a first end portion of the interlocking link is connected to a bottom portion of the second temperature door plate by a hinge, and a second end portion thereof is formed with a rack gear by a fixed length therefrom, the rack gear engaging with the temperature door drive gear.

8. The vehicle HVAC system of claim 7, wherein the temperature door drive gear further includes an interlocking gear formed integrally with the temperature door drive gear while engaging with the rack gear of the interlocking link.

9. The vehicle HVAC system of claim 6, wherein, during cooling of the vehicle internal, a refrigerant flows to the evaporator core while the first and second temperature door plates slide in a direction adjacent to each other to close between the first guide and the second guide, so that an air flow to the heater core is blocked.

10. The vehicle HVAC system of claim 6, wherein, during heating of the vehicle internal, a heated fluid flows to the heater while the first and second temperature door plates slide in a direction away from each other so that the second temperature door plate closes between the first guide and the associated internal surface of the housing and between the second guide and another internal surface of the housing.

11. The vehicle HVAC system of claim 6, wherein, when the vehicle internal is required to be air-conditioned between cooling and heating, a refrigerant flows to the evaporator core and a heated fluid flows to the heater core while the first and second temperature door plates slide in a direction adjacent to each other to be distanced from each other by a predetermined distance.

12. The vehicle HVAC system of claim 1, wherein
the vent outlet is formed adjacent to the floor outlet;
the mode door plate slides between an inlet of the vent outlet and an inlet of the floor outlet in the mode door assembly; and
the mode door assembly further includes a mode door drive gear rotated by a drive motor to slide the mode door plate.

13. The vehicle HVAC system of claim 12, wherein
the mode door plate has a rack gear formed in a sliding direction of the mode door plate on a bottom portion thereof; and
the mode door drive gear engages with the rack gear.

14. The vehicle HVAC system of claim 12, wherein, when a vent mode is set such that the conditioned air is discharged to the predetermined direction, the mode door plate opens the vent outlet and closes the floor outlet.

15. The vehicle HVAC system of claim 12, wherein, when a floor mod is set such that the conditioned air is discharged to a floor of the vehicle internal, the mode door plate closes the vent outlet and opens the floor outlet.

16. The vehicle HVAC system of claim 12, wherein, when a bi-level mod is set such that the conditioned air is discharged to the predetermined direction and to a floor of the vehicle internal, the mode door plate partially opens the vent outlet and the floor outlet.

17. The vehicle HVAC system of claim 1, wherein the housing is provided therein with a bracket that fixes a supply pipe for supply of a heated fluid into the heater core, a discharge pipe for discharge of the fluid having passed through the heater core, a refrigerant pipe for supply of a refrigerant to an expansion valve, and a discharge tube for discharge of the refrigerant having passed through the evaporator core.
